(19) United States
(12) Patent Application Publication
(10) Pub. No.: US 2002/0136375 A1
(43) Pub. Date: Sep. 26, 2002

(54) System and method for utilization of call processing platform for ecommerce transactions

(76) Inventors: Claude C. Bouffard, Chelsea (CA); John P. Shannon, Dunrobin (CA)

Correspondence Address: Kent E. Baldauf, Jr., WEBB ZIESENHEIM LOGSDON ORKIN & HANSON, P.C., 700 Koppers Building, 436 Seventh Avenue, Pittsburgh, PA, 15219-1818, US

(21) Appl. No.: 10/077,681

(22) Filed: Feb. 15, 2002

Related U.S. Application Data
(63) Continuation of application No. 09/599,463, filed on Jun. 22, 2000.

(51) Int. Cl. H04M 15/00

(52) U.S. Cl. 379/114.01

(57) ABSTRACT

Electronic commerce is enhanced through the use of the state-based management capability of the public telephony infrastructure, adapted for use in Internet and other network transactions. A telephony engine such as the Nortel Networks DMS™ switching platform is configured to initiate, process and terminate electronic transactions such as consumer Web purchase, rather than the telephone events for which such hardware was designed. The transaction engine may, for instance, detect, time and record billing for the logging of a Internet user on to a game site, video download or other service or product. Once a transaction has entered its termination state, analogous to the hanging up of a telephone call, a billing record is generated which is transmitted through the usual billing services of the telephony network. Consumers may therefore locate and pay for a variety of services on the Internet and other networks while relying on the convenience of regular monthly telephone billing.

### CROSS-REFERENCE TO RELATED APPLICATIONS

The subject matter of this application is related to the subject matter of U.S. patent applications Ser. No. 09/219,813 entitled “Arrangement for Billing or Billing Authorization Using A Telecommunication Network”, filed Dec. 23, 1998 and priority being claimed therefrom; Ser. No. 09/310,944 entitled “Sending Billing Messages In A Telephone Network” filed May 13, 1999 and priority being claimed therefrom; Ser. No. 09/368,932 entitled “Arrangement For Billing Or Billing Authorization Using A Calling Card” filed Aug. 5, 1999 and priority being claimed therefrom; Ser. No. ______ entitled “System and Method For Automated Mediation Of Vendor Accounts” filed of even date herewith; Ser. No. ______ entitled “System and Method For Application of Network Access Policy to Ecommerce Transactions” filed of even date herewith; Ser. No. ______ entitled “System and Method For Vendor Account Validation in Electronic Commerce” filed of even date herewith; Ser. No. ______ entitled “System and Method for Anonymous Recharging of Stored Value Accounts” filed of even date herewith; and Canadian Patent Application Serial No. ______ entitled “Method and System For Secure E-Commerce Transactions” filed Dec. 31, 1999 and priority being claimed therefrom, each of which applications is assigned or under obligation of assignment to the same entity or affiliated entity as this application, and each of which is incorporated by reference.

### FIELD OF THE INVENTION

The invention relates to the field of electronic commerce, and more particularly to the adaptation of legacy telephony infrastructure for ecommerce transaction purposes.

### BACKGROUND OF THE INVENTION

The global telecommunications network has long offered the capacity to detect, capture and process telephone call events in a highly reliable and regular fashion. As one example, the Digital Multiplexing System (DMS™) offered by Nortel Networks Limited, Ontario, Canada supports a variety of hardware and software functions which cooperate to register, meter, record and ball dial-up and other telephone events. The DMS™ platform is pseudo-real time system, in that the amount of latency is not guaranteed before initiation of a call event, so that it may take e.g. ¼ sec to receive a dial tone after a telephone is taken off the hook to place a call. However, the DMS™ platform has proved to be a reliable and responsive telephony engine for millions of residential, business and other customers.

The DMS™ platform includes a combination of switching hardware and application software running under the Switch Operating System (SOS), which manages the real time or near-real time operation, memory use and special hardware access of the platform. In the DMS™ standard, one thread running under SOS foundation is the CallProcess (CALLP) application, which is designed to read or detect offhook activity, DTMF digits, to establish line connections and otherwise process ordinary telephone calls. The DMS architecture also runs maintenance (MTEC) and other software modules, under the auspices of SOS.

As illustrated in FIG. 1, call processing under the SOS is essentially a transaction-based system triggered by dial-up or other origination of a telephone event. The CALLP module maintains and originates newly started telephone calls, e.g., indicated by hand sets being picked up, by entering them into an origination queue 202 for progression into a completed telecommunication event. The request for telecommunication resources is read out of the origination queue 202 by the DMS™ hardware, which generates a call state record 204 to reflect the instantaneous condition of the communication transaction.

Once a call event has been registered in a call state record 204, the CALLP module may interrogate line, switching and other resources to establish a connection to a recipient number. Once the switching is complete and the connection is established, the CALLP module drops back into a monitoring state in which the progress of the telephone call is tracked, generating a condensed call state record 206. The condensed call state record 206 is more compact than the call state record 204, since no more actual line switching is required. However information such as call duration metering may be recorded in that data object, using time stamp or other techniques, to track the telephone event until the originating party hangs up.

Billing indicia may then be generated, for instance to pass to regular monthly billing processing. In concert with the SOS and CALLP software, the DMS™ platform also performs other telecommunication functions such as regulating access to telephone lines, performing congestion control, issuing busy signals and others.

The installed base of DMS™ telephone switching hardware, including DMS™ 100, DMS™ 200, DMS™ 300, DMS™ 500 and other series platforms, thus represents an established and well understood engine for the management of telecommunication services. However, the advent of the Internet and other networking technologies has fueled an increasing demand for data network, rather than telephonic network, electronic commerce and other transactions.

In particular, consumer-to-business and business-to-business commerce over the Internet, while growing, has possibly been dampened by the lack of reliable and secure transaction mechanisms. In general, there is no preestablished mechanism linking any given consumer with any given vendor of software, goods, information or other on-line products. A need exists for dependable, universal and robust transaction systems for use on the Internet and other network applications.

### SUMMARY OF THE INVENTION

The invention overcoming these and other problems in the art relates to a system and method for the utilization of call processing plant for ecommerce transactions, in which the transaction resources of the existing telephony infrastructure are redirected toward electronic commerce. In one embodiment, the transaction initiation, metering and billing capability of the Nortel Networks DMS™ platform may be redirected towards online purchasing, software renting or other transactional purposes. In the invention, an existing DMS™ platform may be used to verify or authenticate consumers on the Internet wishing to initiate a transaction, detect an amount of time a service or information is delivered, and generate a billing record for incorporation into regular monthly telephone billing.

The state machine nature of the DMS™ platform may be taken advantage of in the invention to correlate steps in the transaction progression through idle, start, processing and termination states inherent in that machine. Illustrative transactions may include, for instance, the downloading of MP3 music or other liquid audio, video streams, the querying a browser application for information, subscriptions to news or other information sources, or finding language resources for network translation purposes. Upon completion of the network transaction event, the CALLP software module may in one embodiment issue a bill-ready message to the existing billing service architecture of the DMS platform, reporting a transaction on a monthly telephone bill below the telephone service line. Other billing arrangements are possible.

### BRIEF DESCRIPTION OF THE DRAWINGS

The invention will be described with reference to the accompanying drawings, in which like elements are referenced with like numerals.

FIG. 1 illustrates an overall architecture for switching-based processing over the public telecommunications network.

FIG. 2 illustrates call progression according to a model of the DMS™ platform.

FIG. 3 illustrates state machine transitions according to a model of the DMS platform.

FIG. 4 illustrates a network transaction event according to the invention.

FIG. 5 illustrates an overall architecture for transaction processing according to the invention in another regard.

### DETAILED DESCRIPTION OF PREFERRED EMBODIMENTS

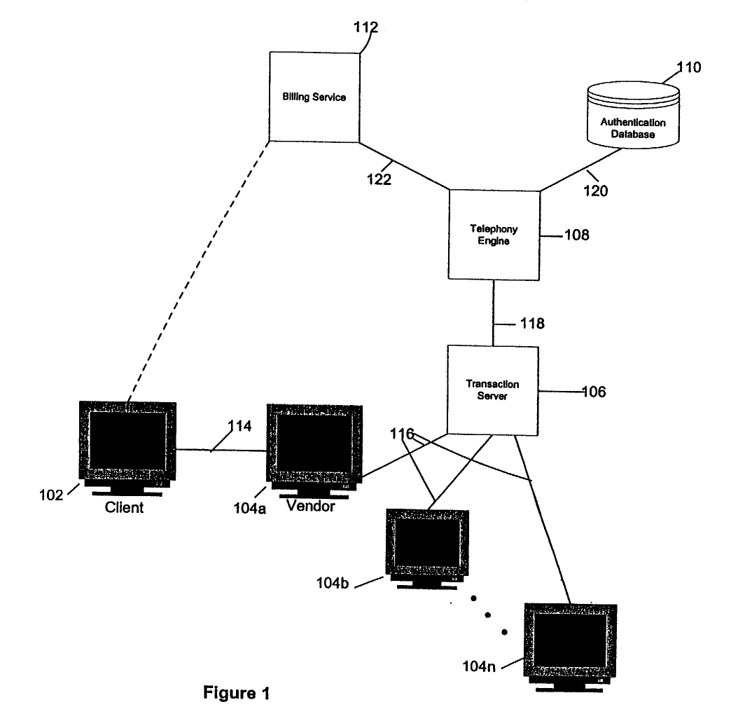

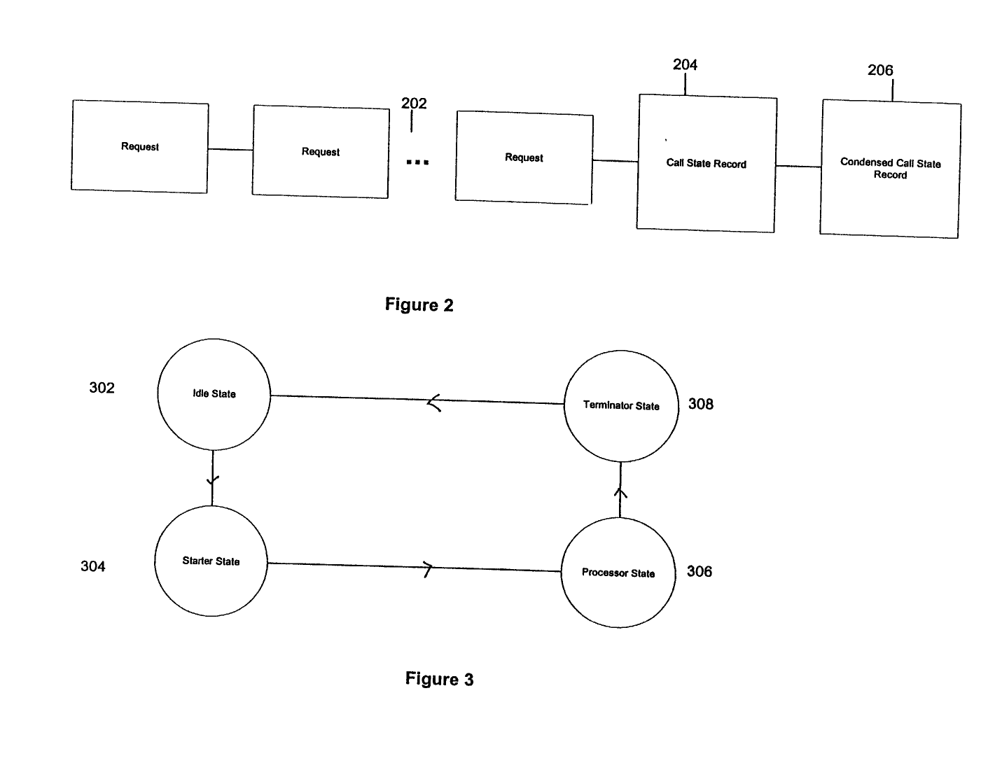

As illustrated in FIG. 1, telephony network switching platforms such as the Nortel Network DMS™ series hardware represent a widely available infrastructure for recording electronic events of a specific type, namely telecommunication services. The system and method of the invention relates to the adaptation of the transaction capabilities of existing telecommunication plant for the separate purpose of electronic commerce, such as Internet transactions.

As illustrated in FIG. 1, in the overall architecture a customer or consumer operating an Internet or other client 102 communicates via communication link 114 to one or more of a group of vendors 104a, 104b, . . . 104n (N arbitrary). The client 102 may be or include, for instance, a personal computer running the Microsoft Windows 95, 98, Millenium™, NT™, or 2000, Windows™ CE™, PalmOS™, Unix, Linux, Solaris™, OS/2™, BeOS™, MacOS™ or other operating system or platform. The client 102 may also be or include a network-enabled appliance such as a WebTV™ unit, radio-enabled Palm™ Pilot or similar unit, a set-top box, a networkable game-playing console such as Sony Playstation or Sega Dreamcast™, a browser-equipped cellular telephone, or other TCP/IP client or other device.

The communications link 114 to which client 102 is connected may be, include or interface to any one or more of, for instance, the Internet, an intranet, a PAN (Personal Area Network), a LAN (Local Area Network), a WAN (Wide Area Network) or a MAN (Metropolitan Area Network), a frame relay connection, an Advanced Intelligent Network (AIN) connection, a synchronous optical network (SONET) connection, a digital T1, T3 or E1 line, Digital Data Service (DDS) connection, DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or FDDI (Fiber Distributed Data Interface) or CDDI (Copper Distributed Data Interface) connections. The communications link 114 may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. The communications link 114 may yet further be, include or interface to any one or more of an RS-232 serial connection, an IEEE-1394 (Firewire) connection, an IrDA (infrared) port, a SCSI (Small Computer Serial Interface) connection, a USB (Universal Serial Bus) connection or other wired or wireless, digital or analog interface or connection. Other illustrated communications links may include the same types of resources.

The vendor or vendors 104a, 104b . . . 104n communicate with a transaction server 106 via communication link 116, to prepare transaction information for recording and collection. The transaction server 106 may be or include, for instance, a workstation running the Microsoft Windows™ NT™, Windows™ 2000, Unix, Linux, Xenix, IBM AIX, Hewlett-Packard UX, Novell Netware™, Sun Microsystems Solaris™, OS/2™, BeOS™, Mach, Apache, OpenStep™ or other operating system or platform. The transaction server 106 is in turn connected and acts as a front end resource to telephony engine 108 via communications link 118.

The telephony engine 108 may preferably be a Nortel Networks DMS™ 100, 200, 300 or other series hardware dedicated to switching and processing telecommunications resources. Information concerning the hardware and software of these machines may be found in, for example, the Nortel Networks Website located at http://www.nortelnetworks.com/products, and subpages entitled DMS Supernode Data Manager (SDM); DMS-1 Urban; DMS-10; DMS-10 STP; DMS-100; DMS-100 Wireless; DMS-250; DMS-300; DMS-300/250; DMS-500; DMS-GSP; DMS-MTX; DMS-PSN/Programmable Switch; DMS-SSP: DMS-STP; DMS-STP/SSP Integrated Node, and all associated pages and links including Tech Specs thereunder, incorporated by reference.

The telephony engine 108 itself communicates via communications link 120 with authentication database 110 for purposes of transaction validation. The authentication database 110 may be, include or interface to a line information data base (LIDB)-type resource operating under the SS7 signaling standard and accessible in the public telecommunications network, as understood by persons skilled in the art, for purposes of authentication, authorization or other transaction functions. The authentication database 110 may likewise be, include or interface to resources such as the ATT Corp. Billing Validation Application (BVA) or the U.S. West Business Validation Service (BVS), or others. The authentication database 110 may further be, include or interface to, for example, the Oracle™ relational database sold commercially by Oracle Corp. Other databases, such as Informix™, DB2 (Database 2) or other data storage or query formats or platforms such as OLAP (On Line Analytical Processing), SQL (Standard Query Language), Microsoft Access™ or others may also be used, incorporated or accessed in the invention.

The telephony engine 108 is also connected via communications link 122 to a billing service 112, such as the billing infrastructure of a local or long distance telephone company. The billing service 112 may be a local or. remote service deployed for the purpose of recording and forwarding transaction bills generated by the telephony engine 108 in junction with transaction server 106. The billing service 112 may forward the bills to the consumer via regular mail, electronic mail, online account login or by other techniques on a monthly or other basis.

As illustrated in FIG. 3, the DMS™ platform when functioning as telephony engine 108 may be modeled as a finite state machine including a series of states which are entered at various points of transaction processing. The idle state 302 may be entered when the telephony engine 108 is awaiting the receipt of a transaction to be processed. The starter state 304 may be triggered or entered upon the receipt of an indication from any input port of a begin-event code. In an existing telephony implementation, those begin-event codes may include or relate to a live starter flag, a trunk starter flag or others.

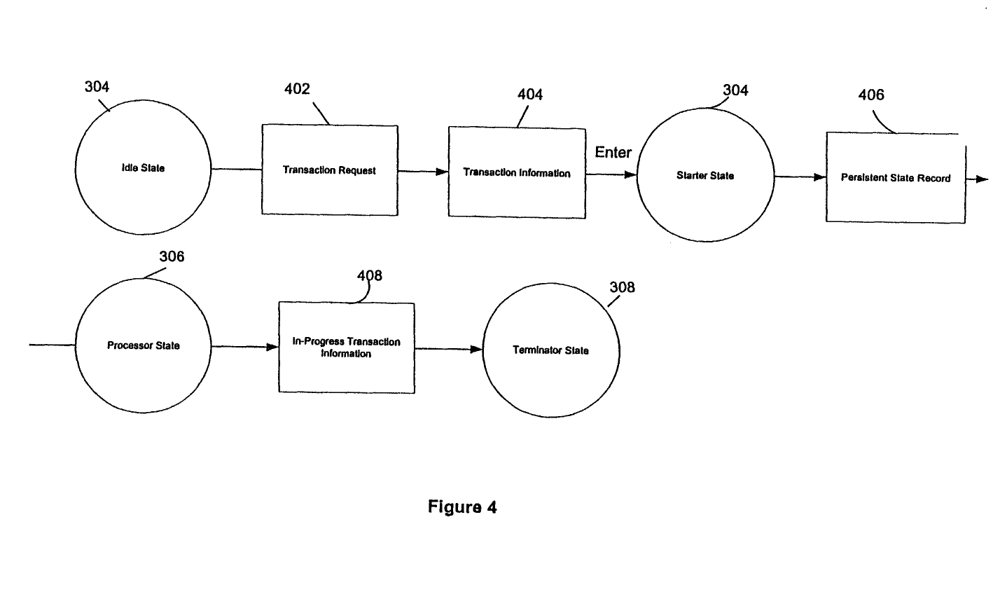

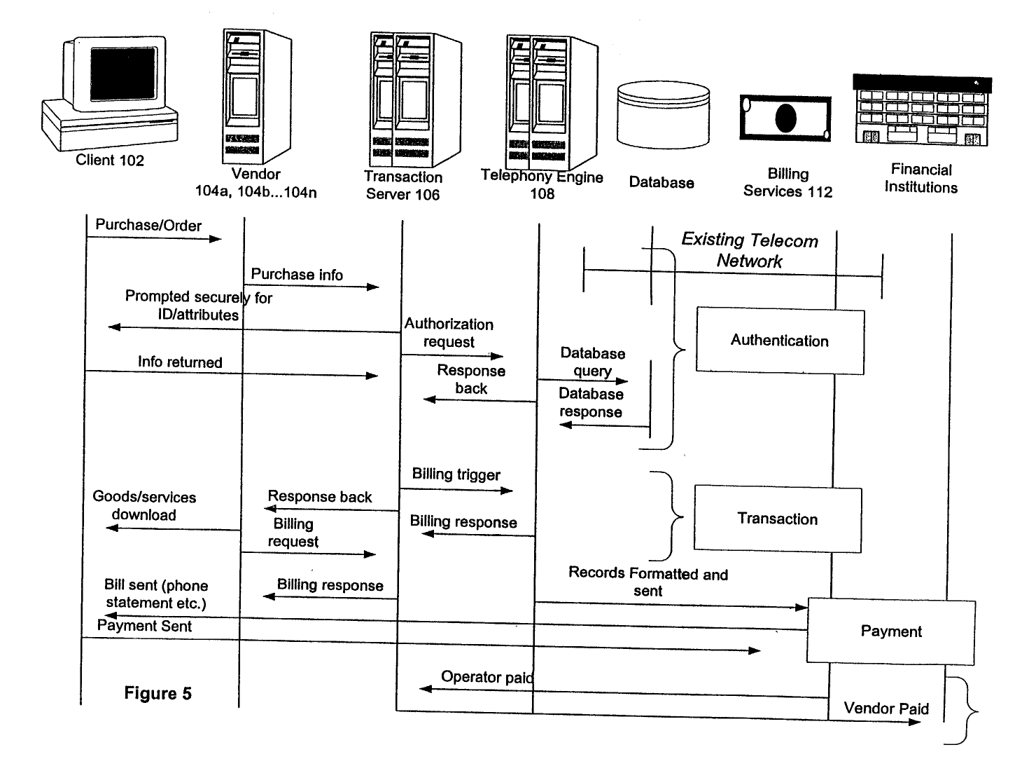

In contrast, according to the invention the starter state 304 may be triggered by or entered upon receipt of flags or other indicators of an authentication starter, a download starter e.g. for liquid audio, video or other downloads, a query browser starter, an information source such as streaming financial data, a language find starter, or others. The starter state 304 may, for instance, be entered after receipt of a transaction request 402 from origination queue 202, which is resolved to transaction information 404 by the CALLP module running on telephony engine 108, as illustrated in FIG. 4.

The incoming transaction request 402 may, for example, be the result of an Internet user clicking on a “buy” radio button on a browser screen. The transaction request 402 may include an originating IP address, Java, HTML or XML code or code fragments, a dialog for further information, or other triggering instances, events or information. Starter state 304 may also be null, if the transaction being serviced does not require an input, validation or other action at that point.

The starter state 304 may create a persistent state record 406 against which the contents of transaction request 402, such as, for example, terminal ID, a language designation (e.g., English), an originating IP or other address, a credit card account number, limit or other information, or other associated information necessary to drive the electronic transaction may be recorded. The persistent state record 406 generated in the starter state 304 of the telephony engine 108 may request further dialog with the originating consumer in order to complete the persistent state record 406.

Once the persistent state record 406 is completed, control is passed to the processor state 306, to manage a transaction request 402 in progress. After a transaction enters the processor state 306, the processor state 306 may enter a wait state awaiting the receipt of further inputs or control actions on the part of the consumer, such as a pause button click during receipt of streaming video. Other control actions are possible, in conjunction with which in-progress transaction information 408 may be built up.

After the processor state 306 receives all necessary inputs, all corollary actions are complete and in-progress transaction information 408 is completely assembled, control may pass to the terminator state 308 in which the transaction action is closed off.

In terminator state 308, transaction metrics may be calculated, such as to calculate a total elapsed time of video streaming for the purposes of billing. This may be accomplished by subtracting begin and end time stamp indications from the persistent state record 406 or a condensed or adapted version thereof, to allocate on-line charges, for further instance to multi-player game rentals, metered database access, or other purposes.

The terminator state 308 may likewise generate a signal to cut a billing record for transmission to billing services 112 of the public telecommunications network, or otherwise. Once the closing actions of the terminator state 308 are complete, control may pass to the idle state 302 awaiting the receipt of new transaction initiation or otherwise.

The connection-tracking management of the invention may thus be used, for example, to record the entry of a user into a virtual private network (VPN), for data upload, video conferencing or other purposes. In the context of the invention, the various states of the telephony engine 108 thus may be mapped into stages of transaction processing which naturally supports the initiation, validation, metering and billing of network commerce. Fields within records generated by the DMS™ or other platforms containing, for additional instance, a directory number (DN) may be mapped to an Internet protocol (IP) address to record originating or terminating transaction recipients.

As noted, upon competition of the terminator state 308 a signal may be transmitted to the billing services 112, such as by a “bill-ready” message indicator communicating that a direct transaction record for billing has been prepared. Upon acceptance by the billing services 112, the transaction information appropriate to record and present to a customer in a regular monthly telephone or other bill is stored for periodic generation.

For instance, the statements generated by billing services 112 may be prepared in batch format a local telephone company invoice or statement indicating a summary of local and long distance telephone usage, followed by an entry such as “Internet access” or “Internet purchases” followed by descriptions of online downloads, logged in game time, or other summaries.

The consumer may therefore aggregate much or all of their online commercial activity in the form of a familiar telephone statement, and transmit payments for all such aggregated consumption to the billing services 112 for redistribution or crediting according to monthly account or other arrangements with one or more of vendors 104a, 104b, 104n, in participating programs. Because the telephony engine 108 and associated elements are well developed and understood by technicians and others, expected down time due to hardware or software failure in the practice of the invention is small, and the reliability and universality of electronic commerce is enhanced.

An overall architecture according to the invention in another regard is illustrated in FIG. 5, in which the interconnection of the transaction server 106, a telephony engine 108 such as the Nortel Networks DMS™ platform for metering, billing or other associated services, the vendor transaction site or sites such as Web pages or other portals, the client and other aspects are shown.

In general, according to the overall architecture in which the invention in one embodiment may operate, consumers may initiate and execute transactions over a dial-up, broadband or other Internet or other network connections, which transactions may be monitored and mediated via transaction server 106, telephony engine 108 along with attendant database, communications and other resources. The messaging traffic between the consumer and the vendor, and between the vendor and the authentication resources, again may be of a partial, anonymous and/or secure nature.

This is at least in part because the invention does not demand the transmission of complete identity or account information, whether in the clear, encrypted or otherwise, at any one stage of the transaction process. Rather, a subset of selected attributes, fields or keywords may be queried between the consumer and the commercial vendor for the separate transmission to the party, company or other organization operating the transaction server 106, telephony engine 108 or authentication database 110, and only the party providing the authentication function necessarily records more complete information in order to carry out that task. As shown in that figure and described above, billing against the consumer's account, telephone bill or otherwise may be triggered by a validated authentication sequence whose details may never be communicated to the vendor. The vendor may consequently receive payment directly or indirectly from banks or other financial intermediaries separately after that process, with whom the consumer separately reconciles. Transaction privacy and flexibility for consumers are therefore enhanced.

The foregoing description of the invention is illustrative, and variations in configuration and implementation will occur at persons skilled in the art. For instance, while the invention has been described with respect to an architecture in which a single telephony engine 108 services one or more online vendors, two or more telephony engines could be combined or linked to cooperatively process vending and other transactions. Other resources such as computing, data, communications or other resources illustrated as singular or standalone may likewise be distributed, and one or more separate resources may be combined. Likewise, companies, organizations or other parties operating or supervising different segments of the processing chain could be one in the same, so for example authentication entities could also own or operate the transaction engine or engines, or other resources. Moreover, while the invention has been generally been described with respect to purchase transactions involving the debiting of the consumer's account, in another embodiment steps of the transaction processing may be executed in reverse manner to recharge, refund or otherwise credit the consumer's account.

Likewise, while the invention has been described with respect to the adaptation of the Nortel Networks DMS™ platform for generalized transaction use, other switching and other equipment could be utilized in a redirected manner as contemplated herein. The scope of the invention is accordingly intended to be limited by the following claims.

What is claimed is:

1. A system for the management of electronic transactions, comprising:
a first interface to a public telecommunications resource; and
a second interface, communicating with the first interface, the second interface operative to communicate with at least one network-enabled transaction site to execute a transaction via the transaction site using the public telecommunications resource to record and manage the transaction.

2. The system of claim 1, wherein the public telecommunications resource comprises a switching apparatus embedded in the public telecommunications network.

3. The system of claim 2, wherein the switching apparatus comprises a state machine having states.

4. The system of claim 3, wherein the states of the state machine comprise at least an idle state, a starter state, a processor state, and a terminator state.

5. The system of claim 4, wherein each of the states of the state machine correspond to a stage of the transaction.

6. The system of claim 5, wherein the idle state comprises a state awaiting initiation of a consumer transaction.

7. The system of claim 5, wherein the starter state comprises a state detecting a transaction request signal for the transaction.

8. The system of claim 7, wherein the transaction request signal comprises at least one of a download start signal, a search signal, a purchase signal, and a query signal.

9. The system of claim 8, wherein the starter state generates a persistent state record reflecting the transaction.

10. The system of claim 5, wherein the processor state comprises a state detecting the metered elapse of the transaction.

11. The system of claim 10, wherein the processor state generates an in-progress transaction record of the transaction.

12. The system of claim 5, wherein the terminator state comprises a state closing off actions for the transaction.

13. The system of claim 12, wherein the terminator state generates a billing record for the transaction.

14. The system of claim 1, wherein the network-enabled transaction site comprises an Internet connection.

15. The system of claim 14, wherein the network-enabled transaction site comprises a Web site.

16. A method for the management of electronic transactions, comprising:
a) interfacing to a public telecommunications resource at a first interface; and
b) communicating with at least one network-enabled transaction site to execute a transaction via the transaction site using the public telecommunications resource to record and manage the transaction.

17. The method of claim 16, wherein the public telecommunications resource comprises a switching apparatus embedded in the public telecommunications network.

18. The method of claim 17, wherein the switching apparatus comprises a state machine having states.

19. The method of claim 3, wherein the states of the state machine comprise at least an idle state, a starter state, a processor state, and a terminator state.

20. The method of claim 19, wherein each of the states of the state machine correspond to a stage of the transaction.

21. The method of claim 20, wherein the idle state comprises a state awaiting initiation of a consumer transaction.

22. The method of claim 20, wherein the starter state comprises a state detecting a transaction request signal for the transaction.

23. The method of claim 22, wherein the transaction request signal comprises at least one of a download start signal, a search signal, a purchase signal, and a query signal.

24. The method of claim 23, wherein the starter state generates a persistent state record reflecting the transaction.

25. The method of claim 20, wherein the processor state comprises a state detecting the metered elapse of the transaction.

26. The method of claim 25, wherein the processor state generates an in-progress transaction record of the transaction.

27. The method of claim 20, wherein the terminator state comprises a state closing off actions for the transaction.

28. The method of claim 27, wherein the terminator state generates a billing record for the transaction.

29. The method of claim 16, wherein the network-enabled transaction site comprises an Internet connection.

30. The method of claim 29, wherein the network-enabled transaction site comprises a Web site.
